(19) United States
(12) Patent Application Publication
(10) Pub. No.: US 2020/0399173 A1
(43) Pub. Date: Dec. 24, 2020

(54) METHOD FOR MINIMIZING DENT DEFECTS IN CHEMICALLY STRENGTHENED GLASS

(71) Applicant: CORNING INCORPORATED, CORNING, NY (US)

(72) Inventors: Jaymin Amin, Corning, NY (US); Matthew John Dejneka, Corning, NY (US); Yuhui Jin, Painted Post, NY (US); Robert George Manley, Vestal, NY (US); Jonathan Michael Mis, Horseheads, NY (US); Pascale Oram, Hammondsport, NY (US); Vitor Marino Schneider, Painted Post, NY (US); Charlene Marie Smith, Corning, NY (US); Wei Sun, Painted Post, NY (US); Wanda Janina Walczak, Big Flats, NY (US); Liying Zhang, Painted Post, NY (US)

(21) Appl. No.: 16/979,280

(22) PCT Filed: Mar. 8, 2019
(86) PCT No.: PCT/US19/21274

§ 371 Date: Sep. 9, 2020

Related U.S. Application Data
(60) Provisional application No. 62/640,792, filed on Mar. 9, 2018.
(60) Provisional application No. 62/800,629, filed on Feb. 4, 2019.

(51) Int. Cl. C03C 21/00; C03C 23/00; C03C 4/18; C03C 3/093; C03C 3/097

(52) U.S. Cl. CPC C03C 21/002; C03C 23/0075; C03C 23/006; C03C 2204/00; C03C 3/093; C03C 3/097; C03C 4/18

(57) ABSTRACT

Methods of manufacturing a glass-based article comprise: after mechanical polishing of a glass-based substrate, treating at least one surface of the glass-based substrate for protection of the at least one surface from contamination and/or for removal of contaminants from the at least one surface by a treatment other than ultrasonic cleaning; and exposing the glass-based substrate to an ion exchange treatment after the treating step to form the glass-based article. The treating step includes: exposing the at least one surface to a high pH soaking for removal of contaminants; deionizing the at least one surface for removal of contaminants; and/or applying a temporary coating to the at least one surface for protection of the at least one surface from contamination, and removing the temporary coating prior to the ion exchange treatment step. The ion exchange treatment may comprise a molten salt bath having an increased pH and temperature.

### CROSS-REFERENCE TO RELATED APPLICATIONS

This application claims the benefit of priority under 35 U.S.C. § 119 of U.S. Provisional Application Ser. No. 62/800,629 filed on Feb. 4, 2019 and U.S. Provisional Application Ser. No. 62/640,792 filed on Mar. 9, 2018, the content of each is relied upon and incorporated herein by reference in their entirety.

### FIELD

The present disclosure generally relates to a method for minimizing dent defects in chemically strengthened glass, particularly removing stains and dust particles on the glass prior to strengthening the glass.

### BACKGROUND

Glass-based articles have been widely applied as cover plates or windows for consumer electronic devices such as mobile phones, smart phones, tablets, video players, information terminal (IT) devices, laptop computers, navigation systems and the like. Glass-based articles are suitable for any application that requires superior fracture resistance but thin and light-weight articles. Mechanical and/or chemical reliability of the glass-based articles is typically driven by functionality, performance, and cost. Improving the mechanical and/or chemical reliability of these articles is an ongoing goal.

Chemical treatment is a strengthening method to impart a desired/engineered/improved stress profile having one or more of the following parameters: compressive stress (CS), depth of compression (DOC), and central tension (CT). Many glass-based articles, including those with engineered stress profiles, have a compressive stress that is highest or at a peak at the glass surface and reduces from a peak value moving away from the surface, and there is zero stress at some interior location of the glass article before the stress in the glass article becomes tensile. Chemical strengthening by ion exchange (IOX) of alkali-containing glass is a proven methodology in this field.

Glass surfaces are strengthened by replacing smaller monovalent metal ions with larger ones in an ion exchange process. The ion exchange process generates surface compressive stress (CS) and makes the glass surface harder to break if the glass is dropped or otherwise subjected to an impact force. However, if the ion-exchange process is not uniform, then the CS might not be uniform across the surface, which could lead to the undesirable formation of stress-induced dents in the surface. Accordingly, there is a need to develop a method to minimize the formation of dent defects in chemically strengthened glasses.

### SUMMARY

Aspects of the disclosure pertain to glass-based articles and methods for their manufacture.

The present disclosure provides methods for minimizing dent defects as defined as a dent with a depth of more than 40 nm and a width of more than 200 microns.

In an aspect, methods of manufacturing a glass-based article comprise: treating at least one surface of a glass-based substrate for protection of the at least one surface from contamination and/or for removal of contaminants from the at least one surface by a treatment other than ultrasonic cleaning; and exposing the glass-based substrate to an ion exchange treatment after the treating step to form the glass-based article.

In another aspect, methods of manufacturing a glass-based article comprise: obtaining a glass-based substrate having finished edges, optional mechanical polishing of one or more surfaces of the glass-based substrate; ultrasonic cleaning of the glass-based substrate to form a cleaned substrate; quality control inspecting of the cleaned substrate; loading the cleaned substrate; preheating the cleaned substrate; and ion exchange treating the cleaned substrate, wherein the improvement comprises: before the ultrasonic cleaning, exposing the at least one surface to a high pH soaking for removal of contaminants; after the loading and before the preheating, ionizing the at least one surface for removal of contaminants; and/or after the ultrasonic cleaning and before the loading, applying a temporary coating to the at least one surface for protection of the at least one surface from contamination, and removing the temporary coating by heating prior to the ion exchange treating step.

Another aspect provides: methods of manufacturing a glass-based article comprising: exposing at least one surface of a glass-based substrate to a high pH soaking for removal of contaminants; exposing the glass-based substrate to at least one additional finishing step; and exposing the glass-based substrate to an ion exchange treatment to form the glass-based article.

A further aspect is methods of manufacturing a glass-based article comprising: applying a temporary coating to at least one surface of a glass-based substrate to protect the at least one surface from contamination; exposing the glass-based substrate to at least one additional finishing step; heating the glass-based substrate to remove the temporary coating; and after the temporary coating is removed, exposing the glass-based substrate to an ion exchange treatment to form the glass-based article.

In another aspect, methods of manufacturing a glass-based article comprise: ionizing a glass-based substrate to form an ionized glass-based substrate; heating the ionized glass-based substrate to form a heated, ionized glass-based substrate; and exposing the heated, ionized glass-based substrate to an ion exchange treatment to form the glass-based article.

An additional aspect includes methods of manufacturing a glass-based article comprising: heating a glass-based substrate; and exposing the glass-based substrate to an ion exchange treatment comprising self-cleaning conditions to form the glass-based article.

Other aspects include: methods of reducing birefringement defects during manufacturing a glass-based article comprising: removing contaminants on at least one surface of a glass-based substrate by: exposing the at least one surface to a high pH soaking for removal of contaminants; and/or ionizing the at least one surface for removal of contaminants; optionally applying a temporary coating to the at least one surface for protection of the at least one surface from contamination, and removing the temporary coating; and exposing the glass-based substrate to an ion exchange treatment to form the glass-based article.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an exemplary flowchart of processing steps according to prior art;

FIG. 2 is an exemplary schematic of sources of contamination showing how dents can form from stains left from mechanical polishing and/or the accumulation of dust particles;

FIG. 3 is an exemplary schematic of mechanisms occurring in an ion exchange bath;

FIG. 4 is an exemplary flowchart of processing steps to reduce the formation of dents according to an embodiment;

FIG. 5 is another exemplary flowchart of processing steps to reduce the formation of dents according to an embodiment;

FIG. 6 is another exemplary flowchart of processing steps to reduce the formation of dents according to an embodiment;

FIG. 7 is a chart showing the defect rate comparing the results of (a) processes with and without a YSAM coating and (b) processes with and without an ionization step; and

FIG. 8 is a chart showing the defect rate for various IOX bath temperatures.

### DETAILED DESCRIPTION

Before describing several exemplary embodiments, it is to be understood that the disclosure is not limited to the details of construction or process steps set forth in the following disclosure. The disclosure provided herein is capable of other embodiments and of being practiced or being carried out in various ways.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment. Furthermore, the particular features, structures, materials, or characteristics may be combined in any suitable manner in one or more embodiments.

### Definitions and Measurement Techniques

The terms “glass-based article” and “glass-based substrates” are used to include any object made wholly or partly of glass. Laminated glass-based articles include laminates of glass and non-glass materials, laminates of glass and crystalline materials. Glass-based substrates according to one or more embodiments can be selected from alkali-alumino silicate glass, alkali-containing borosilicate glass, and alkali-containing aluminoborosilicate glass.

A “base composition” is a chemical make-up of a substrate prior to any ion exchange (IOX) treatment. That is, the base composition is undoped by any ions from IOX. A composition at the center of a glass-based article that has been IOX treated is typically the same as the base composition when IOX treatment conditions are such that ions supplied for IOX do not diffuse into the center of the substrate. In one or more embodiments, a composition at the center of the glass article comprises the base composition.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass-based article that is “substantially free of MgO” is one in which MgO is not actively added or batched into the glass-based article, but may be present in very small amounts as a contaminant.

Unless otherwise specified, all compositions described herein are expressed in terms of mole percent (mol %) on an oxide basis.

A “stress profile” is a plot of stress with respect to position of a glass-based article. A compressive stress region, where the glass-based article is under compressive stress, extends from a first surface to a depth of compression (DOC) of the article. A central tension region extends from the DOC and includes the region where the glass-based article is under tensile stress.

As used herein, depth of compression (DOC) refers to the depth at which the stress within the glass-based article changes from compressive to tensile stress. At the DOC, the stress crosses from a positive (compressive) stress to a negative (tensile) stress and thus exhibits a stress value of zero. According to the convention normally used in mechanical arts, compression is expressed as a negative (<0) stress and tension is expressed as a positive (>0) stress. Throughout this description, however, compressive stress (CS) is expressed as a positive or absolute value—i.e., as recited herein, CS=|CS|. In addition, tensile stress is expressed herein as a negative (<0) stress. Central tension (CT) refers to tensile stress in a central region or a central tension region of the glass-based article. Maximum central tension (maximum CT or CTₘₐₓ) refers to the maximum tensile stress in the central tension region. In some embodiments, maximum CT occurs in the central tension region nominally at 0.5·t, where t is the article thickness.

Unless otherwise specified, CT and CS are expressed herein in megaPascals (MPa), thickness is express in millimeters and DOC and DOL are expressed in microns (micrometers).

Compressive stress (including surface/peak CS, CSₘₐₓ) and spike depth of layer (DOLₛₚ) are measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

The knee stress CSk is defined as the value of compressive stress that the deeper portion of the CS profile extrapolates to at the depth DOLₛₚ.

The maximum CT value is measured using a scattered light polariscope (SCALP) technique known in the art.

DOC may be measured by FSM or SCALP depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile).

Refracted near-field (RNF) method may also be used to measure attributes of the stress profile. When the RNF method is utilized, the maximum CT value provided by SCALP is utilized. In particular, the stress profile measured by the RNF method is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass-based article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

Dent (birefringement) defects can be observed under a strainscope with cross-polarized light, using for example, a PSV-590 cross-polarizer. Defects can be quantified using an interferometer such as a ZYGO® NEWVIEW™ 7300 Optical Surface Profiler manufactured by ZYGO® Corporation. Defects can be classified as Level A, Level B, Level C, or Level D. Level A dents are the lightest/smallest dent and most difficult to observe; and Level D dents are the heaviest/largest and easiest to observe. Level A dents have a depth of less than 30 nm. Level B dents have a depth in from about 30 to 80 nm. Level C dents have a depth greater than 80 nm and are easily observed. Level D dents are defined as line defects, in contrast to Levels A-C dents which are dot defects.

### Enhanced Finishing Steps Prior to Ion Exchange (IOX) Treatment

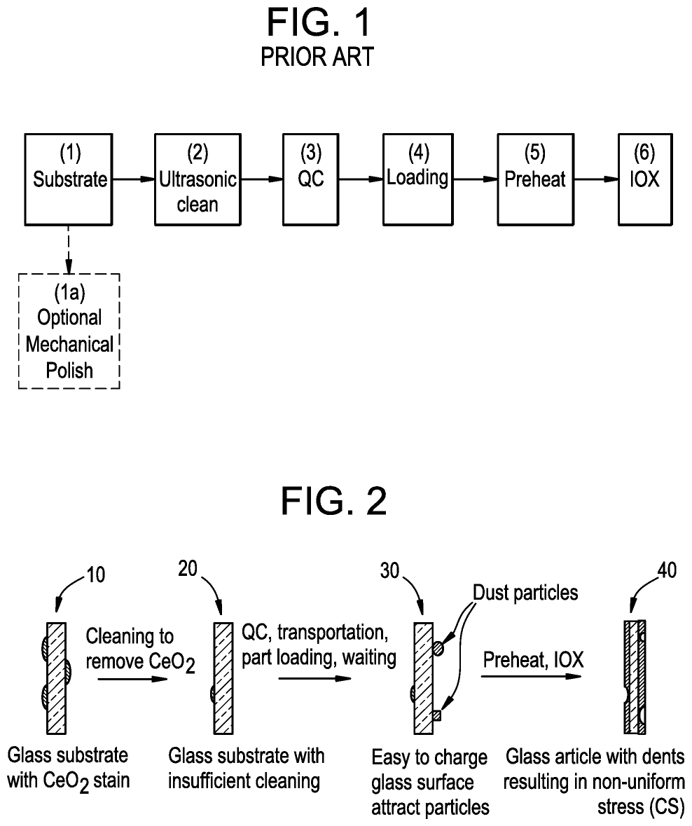

Ion exchangeable glasses (for example alkalialuminosilicate glasses) often go through a series of finishing steps before they are ion exchanged, including one of more of: optional mechanical polishing, cleaning (for example, ultrasonic cleaning), quality control (QC) inspection, loading, and preheating as shown for example in FIG. 1 as steps (1a)-(5), respectively, preceding the IOX step (6). That is, to begin, a glass substrate is received from a bulk process (1) after manufactured sheets of glass have cooled to room temperature and been scored and cut into substrates, whose edges are finished by, for example edge polishing. In practice, a sheet of glass is cut into a plurality of substrates, which are then housed in a cassette, usually a plastic cassette for the finishing steps through QC after the plurality of substrates are loaded into a cassette or rack, typically made out of metal for preheat and IOX. In some embodiments, some finishing steps are conducted in a clean room, e.g., ultrasonic clean and QC; and later steps, e.g., preheat and IOX are conducted in an IOX area separate from the clean room. Reference herein to methods with respect to a substrate applies both to individual substrates and to a plurality of substrates that are processed at the same time.

In one or more embodiments, the glass substrate has finished edges. Depending on the type of bulk process, the glass substrate may or may not require mechanical polishing. Optionally, one or more surfaces of the glass substrate are mechanically polished (1a) to form a polished substrate. Either the substrate or the polished substrate is then ultrasonically cleaned (2) to form a cleaned substrate. At (3), quality control inspection of the cleaned substrate occurs. The cleaned substrate is then loaded (4) into a cassette or rack, typically a metal cassette or rack for further handling and is then preheated (5). Ion exchange treatment (6) is then conducted on the cleaned substrate.

During the finishing steps (e.g., optional mechanical polish, ultrasonic clean, QC, loading, and preheat), contamination including but not limited to particles and/or residues may reside on surfaces of the glasses, which can interfere with IOX and lead to dents. Turning to FIG. 2, potential sources of contamination are found as follows. When mechanically polished, cerium oxide (ceria/CeO₂) is typically used on the glass substrate surfaces, which may leave residue. In some embodiments, CeO₂ residue and other mechanical polishing particles can stain or remain on surfaces of the substrates after mechanical polishing 10, and are not fully removed during an ultrasonic cleaning step 20. Also in some embodiments, dust particles (both organic and inorganic) may collect after the ultrasonic cleaning during QC, transportation, part loading and waiting before the ion exchange 30. The presence of residue from mechanical polishing and/or collection of dust during ion exchange can result in the surface of the glass under the residue and/or dust not being ion exchanged 40 to the same degree as the remainder of the surface. This can lead to a non-uniform compressive stress (CS) across the surface of the glass, which can lead to surface stress-induced dents. These dents can be observed through a polarized lens, and can be quantified by surface analysis using, for example, an interferometer.

The methods of the present disclosure are advantageous because they minimize visible dent defects as defined as dents with a depth of more than 40 nm and a width of more than 200 microns. The methods are also advantageous for circumstances when there is a delay between the clean room and the IOX area during which substrate surfaces may collect dust.

In general, the methods herein comprise treating at least one surface of a glass-based substrate for protection of the at least one surface from contamination and/or for removal of contaminants from the at least one surface by a treatment other than ultrasonic cleaning. Thereafter, the glass-based substrate is exposed to an ion exchange treatment to form the glass-based article. In an embodiment, the glass-based substrate comprises finished edges. The treating step may comprise one or more of: exposing the at least one surface to a high pH soaking for removal of contaminants; ionizing the at least one surface for removal of contaminants; and applying a temporary coating to the at least one surface for protection of the at least one surface from contamination, and removing the temporary coating prior to the ion exchange treatment step. In one or more embodiments, the treating step is prior to any ion exchange treatment and is in addition to traditional finishing steps.

In some embodiments, the process prior to IOX includes the following steps, which may be conducted individually or in combination:

Soaking the glass after mechanical polishing in a solution, e.g., a strong base (e.g. KOH, NaOH) at high pH (e.g., a pH of greater than or equal to 13) soaking to remove CeO₂ and mechanical polishing particles from glass surface;

Enhancing ultrasonic cleaning conditions by: increasing the cleaning solution temperature, to for example, a range of greater than or equal to 40° C. to less than or equal to 70° C., or even greater than or equal to 40° C. to less than or equal to 60° C., and all values and subranges therebetween; and/or increasing pH (e.g., for ultrasonic cleaning) to a range of from greater than or equal to a pH of 9 to less than or equal to a pH of 14, or even greater than or equal to 10 to less than or equal to 13; and all values and subranges therebetween;

Applying a temporary coating or protection layer on the glass after cleaning to prevent dust from attaching directly to the glass surface and burning off the protection layer during the preheating step; and/or

Ionizing the glass surface.

In some embodiments, the methods disclosed herein minimize and/or prevent Level A-Level D dents. In some embodiments, Level A dents are acceptable and the methods disclosed herein minimize and/or prevent Level B-Level D dents.

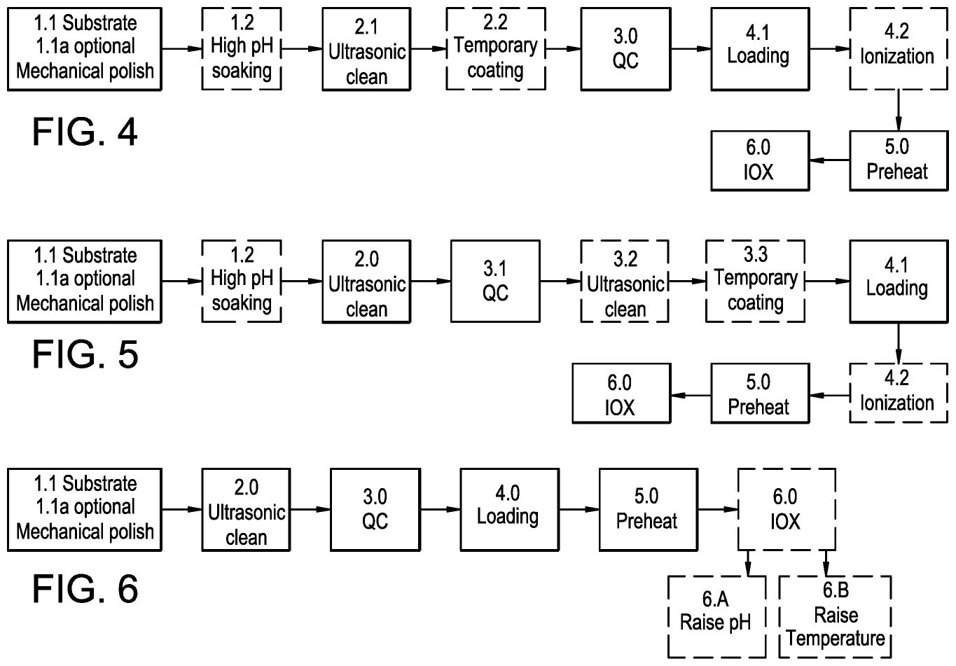

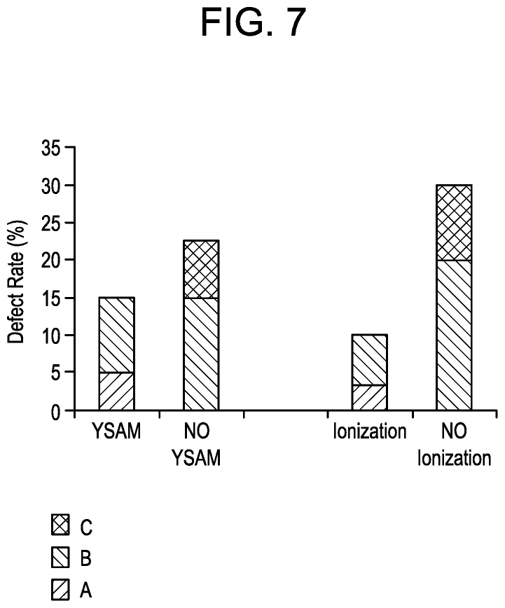

In an embodiment, the process can include the steps outlined in FIG. 4. However, this is merely exemplary and the process can include fewer or additional steps. First, a glass substrate 1.1 can optionally undergo mechanical polishing 1.1a followed by soaking the glass article in a high pH solution, e.g., pH of greater than or equal to 13, 1.2 to remove CeO₂ and mechanical polishing particles from the glass surface. Then the glass substrate undergoes ultrasonic cleaning 2.1 and then a temporary coating may be applied 2.2 to protect the surface from dust and other particles. The coating may be applied to both major surfaces of the glass substrate. The glass substrate may then go through quality control (QC) inspection 3.0 and may then be loaded 4.1, for example, into a rack. Next, the glass substrate may be ionized 4.2 to reduce overall charge of the surfaces in order to remove any particles, e.g., dust particles, and provide cleaning. Then the glass substrate is preheated 5.0 and in some embodiments, the preheating may burn off the temporary coating. Then the glass substrate is ion exchanged 6.0 to form a glass article.

FIG. 5 outlines another exemplary embodiment, which is merely exemplary and the process can include fewer or additional steps. First, a glass substrate 1.1 can optionally undergo mechanical polishing 1.1a followed by soaking the glass article in a high pH solution, e.g., pH of greater or equal to 13, 1.2 to remove CeO₂ and mechanical polishing particles from the glass surface. Then the glass substrate undergoes ultrasonic cleaning 2.0. The glass substrate may then go through quality control (QC) inspection 3.1 and may be subjected to another cycle of ultrasonic cleaning 3.2. Next, a temporary coating may be applied 3.3 to protect the surface from dust and other particles. The coating may be applied to both major surfaces of the glass substrate. The glass substrate may then be loaded 4.1, for example, into a rack. Next, the glass substrate may be ionized 4.2 to reduce overall charge of the surfaces in order to remove any particles, e.g., dust particles, and provide cleaning. Then the glass substrate is preheated 5.0 and in some embodiments, the preheating may burn off the temporary coating. Then the glass substrate is ion exchanged 6.0 to form a glass article.

With respect to a high pH soaking for removal of contaminants, in some embodiments, pH of the solution is greater than or equal to 13, greater than or equal to 13.5, or less than or equal to 14, and all values and subranges therebetween. In an embodiment, the high pH soaking comprises a solution having a pH of greater than or equal to 13 and less than or equal to 14 at a temperature in the range of greater than or equal to 65° C. to less than or equal to 75° C. for a duration in the range of greater than or equal to 10 minutes to less than or equal to 30 minutes, and all values and subranges therebetween. The high pH soaking may further comprise a rinse using deionized water at a temperature in the range of greater than or equal to 65° C. to less than or equal to 75° C. for a duration in the range of greater than or equal to 10 minutes to less than or equal to 30 minutes, and all values and subranges therebetween.

Regarding ionizing at least one surface for removal of contaminants, this may be done at any time, but is preferably done right before preheating in advance of ion exchange treatment. Ionizing may be conducted using, for example an ionization fan or ionized gas. In an embodiment, ionizing comprises applying an ionized gas to the at least one surface of the glass-based substrate.

With further respect to the temporary coating or protection layer, an anti-static coating is preferable to minimize any charge on the substrate surface to keep any contact of dust particles loose with respect to the surface. In one or more embodiments, the temporary coating comprises an organo-silane compound. In a detailed embodiment, the organo-silane compound comprises octadecyldimethyl trimethoxysilylpropyl ammonium chloride. The substrate is at a reduced temperature relative to its bulk process, for example, less than or equal to 170° C. In one or more embodiments, the substrate is at a temperature of greater than or equal to 20° C. and less than or equal to 40° C., and all values and subranges therebetween, when the temporary coating or protection layer is applied. In one or more embodiments, thickness of the temporary coating or protection layer is in the range of 1000 angstroms (Å) to 5 micrometers and all values and subranges therebetween.

The temporary coating or protection layer is applied using techniques known in the art including but not limited to: dipping and spray-coating. The temporary coating or protection layer has a water or solvent solubility that does not change with temperature or pH. In one or more embodiments, the protection layer is chemically bonded to a surface of the glass-based substrate. In one or more embodiments, the organo-silane compound is chemically-bonded to a surface of the substrate. The protection layer, for example, an organo-silane compound, is not removable by dissolution in water.

In an aspect herein, a method of manufacturing a glass-based article comprises: obtaining a glass-based substrate having finished edges, optional mechanical polishing of one or more surfaces of the glass-based substrate; ultrasonic cleaning of the glass-based substrate to form a cleaned substrate; quality control inspecting of the cleaned substrate; loading the cleaned substrate; preheating the cleaned substrate; and ion exchange treating the cleaned substrate, wherein the improvement comprises: before the ultrasonic cleaning, exposing the at least one surface to a high pH soaking for removal of contaminants; after the loading and before the preheating, ionizing the at least one surface for removal of contaminants; and/or after the ultrasonic cleaning and before the loading, applying a temporary coating to the at least one surface for protection of the at least one surface from contamination, and removing the temporary coating by heating prior to the ion exchange treating step. This aspect may include any of the following individually or in any combination as described herein:
the ion exchange treating may comprise a molten salt bath, the method comprising further adding a salt to increase pH of the molten salt bath and/or setting a temperature of the molten salt bath to greater than or equal to 460° C.;
the ultrasonic cleaning may comprise an ultrasonic bath having a pH in the range of greater than or equal to a pH of 9 to less than or equal to a pH of 13 and a temperature in the range of greater than or equal to 40° C. to less than or equal to 70° C.;
after the quality control inspecting and before the loading, exposing the cleaned substrate to a second ultrasonic cleaning; and/or
after the ion exchange treatment, at least one surface of the glass-based article is free of dents having a depth greater than 80 nm.

In an aspect herein, a method of manufacturing a glass-based article comprises: exposing at least one surface of a glass-based substrate to a high pH soaking for removal of contaminants; exposing the glass-based substrate to at least one additional finishing step; and exposing the glass-based substrate to an ion exchange treatment to form the glass-based article. This aspect may include any of the following individually or in any combination as described herein:
the high pH soaking comprises a solution having a pH of greater than or equal to 13 and less than or equal to 14 at a temperature in the range of greater than or equal to 65° C. to less than or equal to 75° C. for a duration in the range of greater than or equal to 10 minutes to less than or equal to 30 minutes; and all values and subranges therebetween;
the at least one further finishing step comprises ultrasonic cleaning of the glass-based substrate;
ionizing the at least one surface prior to the exposing of the glass-based substrate to the ion exchange treatment;
applying a temporary coating to at least one surface of a glass-based substrate and heating the glass-based substrate to remove the temporary coating prior to the exposing of the glass-based substrate to the ion exchange treatment; and/or
after the ion exchange treatment, at least one surface of the glass-based article is free of dents having a depth greater than 80 nm.

In an aspect herein, a method of manufacturing a glass-based article comprises: applying a temporary coating to at least one surface of a glass-based substrate to protect the at least one surface from contamination; exposing the glass-based substrate to at least one additional finishing step; heating the glass-based substrate to remove the temporary coating; and after the temporary coating is removed, exposing the glass-based substrate to an ion exchange treatment to form the glass-based article. This aspect may include any of the following individually or in any combination as described herein:
the temporary coating comprises an organo-silane compound;
the organo-silane compound comprises octadecyldimethyl trimethoxysilylpropyl ammonium chloride;
ionizing the glass-based substrate after the applying of the temporary coating and before the heating of the glass-based substrate;
the ionizing comprises applying an ionized gas to the at least one surface to remove any contaminants from the at least one surface of the glass-based substrate;
the exposing of the glass-based substrate to the ion exchange treatment comprises using a molten salt bath comprising one or more nitrate salts;
the molten salt bath has a pH of greater than or equal to 5;
the one or more nitrate salts independently comprise a metal ion selected from the group consisting of: potassium, sodium, and lithium;
the molten salt bath further comprises a pH-changing salt selected from the group consisting of: a nitrite salt, a carbonate salt, a sulfate salt, a phosphate salt, and combinations thereof;
the molten salt bath comprises less than or equal to 1 weight % of the pH-changing salt in total;
the pH-changing salt comprises a nitrite salt that is sodium nitrite or potassium nitrite, or a carbonate salt is sodium carbonate or potassium carbonate, or combinations thereof;
subjecting the glass-based substrate to a solution having a pH of at least 13 prior to the applying of the temporary coating;
cleaning the glass-based substrate prior to the applying of the temporary coating in a detergent solution having a temperature in a range of greater than or equal to 40° C. to less than or equal to 70° C. and a pH in a range of greater than or equal to a pH of 9 to less than or equal to a pH of 13;
the cleaning comprises ultrasonic cleaning;
the exposing of the glass-based substrate to the ion exchange treatment comprises a molten salt bath having at a temperature in a range of greater than or equal to 460° C. to less than or equal to 520° C. and for a period in a range from greater than or equal to 0.5 hours to less than or equal to 12 hours; and all values and subranges therebetween;
the exposing of the glass-based substrate to the ion exchange treatment comprises a molten salt bath having a pH of at least 7; and/or
after the ion exchange treatment, at least one surface of the glass-based article is free of dents having a depth greater than 80 nm.

In an aspect herein, a method of manufacturing a glass-based article comprises: ionizing a glass-based substrate to form an ionized glass-based substrate; heating the ionized glass-based substrate to form a heated, ionized glass-based substrate; and exposing the heated, ionized glass-based substrate to an ion exchange treatment to form the glass-based article. This aspect may include any of the following individually or in any combination as described herein:
the ionizing comprises applying an ionized gas to remove contaminants from the at least one surface of the glass-based substrate;
the exposing of the heated, ionized glass-based substrate to the ion exchange treatment comprises one or more nitrate salts;
the one or more nitrate salts independently comprise a metal ion selected from the group consisting of: potassium, sodium, and lithium;
the molten salt bath further comprises a pH-changing salt selected from the group consisting of: a nitrite salt, a carbonate salt, a sulfate salt, a phosphate salt, and combinations thereof;
the molten salt bath comprises less than or equal to 1 weight % of the pH-changing salt in total;
the pH-changing salt comprises a nitrite salt that is sodium nitrite or potassium nitrite, or a carbonate salt that is sodium carbonate or potassium carbonate, or combinations thereof;
applying a temporary coating to at least one surface of the glass-based substrate before the ionizing;
subjecting the glass-based substrate to a solution having a pH of at least 13 prior to the applying of the temporary coating;
cleaning the glass-based substrate prior to the applying of the temporary coating in a detergent solution having a temperature in a range of greater than or equal to 40° C. to less than or equal to 70° C. and a pH in a range of greater than or equal to a pH of 9 to less than or equal to a pH of 13; and all values and subranges therebetween;
the cleaning comprises ultrasonic cleaning;
the exposing of the glass-based substrate to the ion exchange treatment comprises a molten salt bath at a temperature in a range of greater than or equal to 460° C. to less than or equal to 520° C. and for a period in a range from greater than or equal to 0.5 hours to less than or equal to 12 hours; and all values and subranges therebetween;
the exposing of the glass-based substrate to the ion exchange treatment comprises a molten salt bath having a pH of at least 7; and/or
after the ion exchange treatment, at least one surface of the glass-based article is free of dents having a depth greater than 80 nm.

In an aspect herein, a method of reducing birefringement defects during manufacturing a glass-based article comprises: removing contaminants on at least one surface of a glass-based substrate by: exposing the at least one surface to a high pH soaking for removal of contaminants; and/or ionizing the at least one surface for removal of contaminants; optionally applying a temporary coating to the at least one surface for protection of the at least one surface from contamination, and removing the temporary coating; and exposing the glass-based substrate to an ion exchange treatment to form the glass-based article. This aspect may include any of the following individually or in any combination as described herein:
the glass-based substrate comprises finished edges;
the ion exchange treatment comprises self-cleaning conditions such that a molten salt bath of the ion exchange treatment comprises a pH of greater than or equal to 7 and less than or equal to 11; and/or a temperature of greater than or equal to 460° C. and less than or equal to 520° C.; and all values and subranges therebetween; and/or
after the ion exchange treatment, at least one surface of the glass-based article is free of dents having a depth greater than 80 nm.

### Enhanced Ion Exchange (IOX) Treatment

Chemical strengthening of base glasses is done by placing the ion-exchangeable glass substrates in a molten bath containing cations (e.g., K+, Na+, Ag+, etc) that diffuse into the glass while the smaller alkali ions (e.g., Na+, Li+) of the glass diffuse out into the molten bath. The replacement of the smaller cations by larger ones creates compressive stresses near the top surface of glass. Tensile stresses are generated in the interior of the glass to balance the near-surface compressive stresses.

With respect to ion exchange processes, they may independently be a thermal-diffusion process or an electro-diffusion process. Non-limiting examples of ion exchange processes in which glass is immersed in multiple ion exchange baths, with washing and/or annealing steps between immersions, are described in U.S. Pat. No. 8,561,429, by Douglas C. Allan et al., issued on Oct. 22, 2013, entitled “Glass with Compressive Surface for Consumer Applications,” and claiming priority from U.S. Provisional Patent Application No. 61/079,995, filed Jul. 11, 2008, in which glass is strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass is strengthened by ion exchange in a first bath is diluted with an effluent ion, followed by immersion in a second bath having a smaller concentration of the effluent ion than the first bath. The contents of U.S. Pat. Nos. 8,561,429 and 8,312,739 are incorporated herein by reference in their entireties.

With respect to salts to use for ion exchange, nitrate salts are conventional but any suitable salts or combination of salts may be used. For example, the anions to deliver cations for ion exchange may be selected from the group consisting of: nitrates, sulfates, carbonates, phosphates, and combinations thereof.

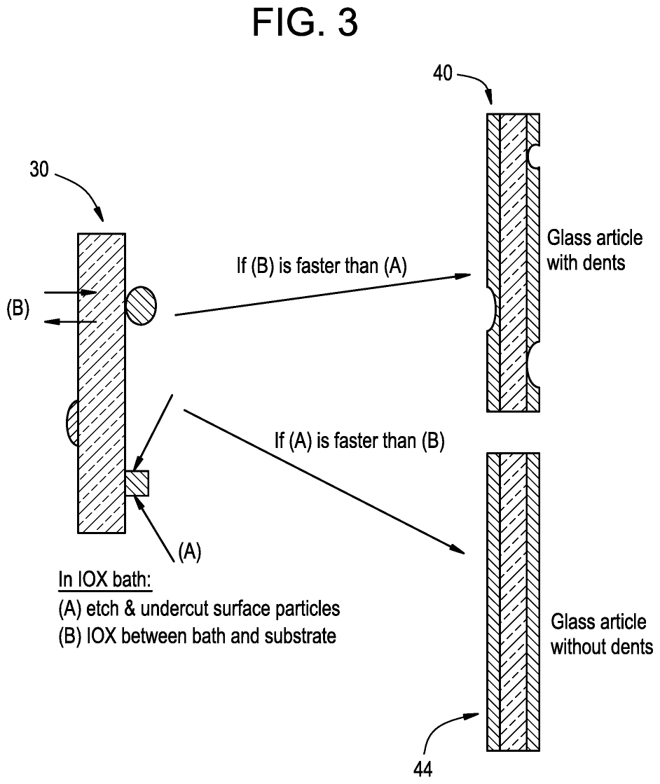

In FIG. 3, a mechanism of forming dents on chemical strengthened glass and a mechanism of ion exchange are depicted schematically. When placing glasses having surface contamination 30 in an IOX bath (comprising one or more molten salt), two processes can occur. In process (A), surface contaminations are slowly removed by glass etching and/or an undercutting process. In process (B), ion exchange between glass and molten salt occurs. If process (A) is quicker, contamination can be removed before significant IOX, which leads to IOX (chemical strengthened) glass showing no dent defects 44. When process (A) is quicker, that is, when etching and/or undercutting are favored over diffusion of metal ions in and out of the surface, the IOX bath is considered to have self-cleaning conditions. If process (A) is slower, or likewise process (B) is quicker, then contamination remains and IOX occurs around the particles, which leads to the IOX glass showing surface dent defects 40.

Factors that influence process (A) are: glass durability, bath temperature, and pH. Factors that influence process (B) are: glass diffusion rate and bath temperature. The two processes (A) and (B) above are both thermally activated. Improving process (A) minimizes formation of surface dents on glass.

The methods of the present disclosure are advantageous because they minimize visible dent defects as defined as dents with a depth of more than 40 nm and a width of more than 200 microns. In embodiments, IOX treatment comprises self-cleaning conditions, which include the following steps, which may be conducted individually or in combination: increasing pH relative to conventional molten salt baths, which are typically in a pH range of 5 to 7, and increasing temperature from a typical range of greater than or equal to 330° C. to less than to 460° C.

Increasing pH of a molten salt bath of the IOX treatment is achieved by adding, for example, a pH-changing salt. For example, when conventional nitrate salts are used in the molten salt bath, the pH-changing salt may be selected from the group consisting of: nitrite salts, carbonate salts, sulfate salts, phosphate salts, or combinations thereof. In one or more embodiments, a nitrite salt (e.g., NaNO₂, KNO₂) and/or a carbonate salt (e.g., NaCO3, KCO3) is added to the ion exchange bath. In one or more embodiments, pH of the molten salt bath is greater than 7, greater than or equal to 7.5, greater than or equal to 8, greater than or equal to 8.5, greater than or equal to 9, greater than or equal to 9.5, greater than or equal to 10, greater than or equal to 10.5, greater than or equal to 11; and less than or equal to 14, and all values and subranges therebetween.

The pH-changing salt may be added by solution to deliver less than or equal to 1% by weight of the molten salt bath, e.g., greater than or equal to 0.1% by weight to less than or equal to 1% by weight, or greater than or equal to 0.25% by weight to less than or equal to 0.8% by weight, or greater than or equal to 0.5% by weight to less than or equal to 0.75% by weight, and all values and subranges therebetween.

In one or more embodiments, the molten salt bath temperature is set to greater than or equal to 460° C. and less than or equal to 520° C., and all values and subranges therebetween. In one or more embodiments, duration of the ion exchange treatment is greater than or equal to 0.5 hours to less than or equal to 12 hours, preferably greater than or equal to 1 hour and less than or equal to 4 hours.

In some embodiments, the methods disclosed herein minimize and/or prevent Level A-Level D dents. In some embodiments, Level A dents are acceptable and the methods disclosed herein minimize and/or prevent Level B-Level D dents.

In an embodiment, the process can include the steps outlined in FIG. 6. However, this is merely exemplary and the process can include fewer or additional steps. First, a glass substrate can undergo mechanical polishing 1.0 followed by ultrasonic cleaning 2.0. The glass substrate may then go through quality control (QC) inspection 3.0 and may then be loaded 4.0, for example, into a rack. Next, the glass substrate is preheated 5.0. Then the glass substrate is ion exchanged 6.0 to form a glass article, where an ion exchange bath is enhanced by an increase in pH 6.A and/or an increase in temperature 6.B.

In addition, the processes of FIGS. 4 and 5 can further include as IOX 6.0, the methods of 6.A and/or 6.B as discussed with respect to FIG. 6.

In an aspect herein, a method of manufacturing a glass-based article comprises: heating a glass-based substrate; and exposing the glass-based substrate to an ion exchange treatment comprising self-cleaning conditions to form the glass-based article. In a detailed embodiment, the self-cleaning conditions comprise a pH of greater than 7 and less than or equal to 11; and/or a temperature of greater than or equal to 460° C. and less than or equal to 520° C. This aspect may include prior to the ion exchange treatment any of the following individually or in any combination as described herein:
treating at least one surface of a glass-based substrate for protection of the at least one surface from contamination and/or for removal of contaminants from the at least one surface by a treatment other than ultrasonic cleaning;
the glass-based substrate comprises finished edges;
exposing the at least one surface to a high pH soaking for removal of contaminants;
ionizing the at least one surface for removal of contaminants; and/or
applying a temporary coating to the at least one surface for protection of the at least one surface from contamination, and removing the temporary coating prior to the ion exchange treatment step.

### General Overview of Properties of Glass-Based Articles

Disclosed herein are glass-based articles having improved surface features where dents defects are minimized.

In one or more embodiments, after ion exchange, at least one surface of the glass-based article is free of dents having a depth greater than 80 nm. Dents may be detected by crosspolarized light with a strainscope and measured by an interferometer.

The glass-based articles may also have a stress profile having a maximum compressive stress (CS) of greater than or equal to 350 MPa, such as greater than or equal to 400 MPa, greater than or equal to 450 MPa, greater than or equal to 500 MPa, greater than or equal to 550 MPa, greater than or equal to 600 MPa, greater than or equal to 650 MPa, greater than or equal to 700 MPa, greater than or equal to 750 MPa, greater than or equal to 800 MPa, greater than or equal to 850 MPa, greater than or equal to 900 MPa, greater than or equal to 950 MPa, greater than or equal to 1000 MPa, greater than or equal to 1050 MPa, or more, and all values and sub-ranges therebetween. In some embodiments, the maximum CS may be located at the surface of the glass-based articles. In one or more embodiments, the glass-based articles include stress profiles that provide improved damage resistance, drop performance, and/or scratch resistance. The glass-based articles may be used in consumer electronics, transportation applications, architectural applications, defense applications, medical applications, packaging applications, and any other applications where a thin, strong glass product is advantageous.

One or more embodiments provide that the glass-based article comprises metal ions at a non-zero concentration that varies from a first surface into a depth of the article. In a detailed embodiment, the glass-based article comprises potassium, sodium, and/or lithium at a non-zero concentration that varies from the first surface to at least a portion of the substrate thickness (t).

One or more embodiments provide that the glass-based article comprises: a Li₂O molar concentration that is less than or equal to 12 mol %, 11 mol %, 10 mol %, 9.5 mol %, 9 mol %, 8.5 mol %, or 8 mol %, and the Li₂O molar concentration at the center of the glass article is greater than or equal to 6.0 mol %. at the center of the glass-based article; and all values and subranges therebetween.

### Glass-Based Substrates

Examples of glass-based substrates that may be used to form the glass-based articles include, but are not limited to: an alkali aluminosilicate glass, an alkali-containing borosilicate glass, an alkali aluminoborosilicate glass, an alkali-containing lithium aluminosilicate glass, or an alkali-containing phosphate glass. The glass-based substrates have compositions that may be characterized as ion exchangeable. As used herein, “ion exchangeable” means that a substrate comprising the composition is capable of exchanging cations located at or near the surface of the substrate with cations of the same valence that are either larger or smaller in size.

Thickness of the substrate (t) may be in the range of greater than or equal to 50 microns to less than or equal to 10 millimeters, such as greater than or equal to 100 micrometers to less than or equal to 9 millimeters, greater than or equal to 200 micrometers to less than or equal to 8 millimeters, greater than or equal to 300 micrometers to less than or equal to 7 millimeters, greater than or equal to 400 micrometers to less than or equal to 6 millimeters, greater than or equal to 500 micrometers to less than or equal to 5 millimeters, greater than or equal to 600 micrometers to less than or equal to 4 millimeters, greater than or equal to 700 micrometers to less than or equal to 3 millimeters, greater than or equal to 800 micrometers to less than or equal to 2 millimeters, greater than or equal to 900 micrometers to less than or equal to 1 millimeter, greater than or equal to 400 micrometers to less than or equal to 800 micrometers, and all values and subranges therebetween.

Exemplary substrates may comprise but are not limited to: alkali aluminosilicate glass, alkali-containing borosilicate glass, alkali-containing aluminoborosilicate glass, and alkali-containing glass-ceramics. In one or more embodiments, the glass-based substrate has an alkali metal oxide content of 2 mole % or greater.

In some embodiments, the glass-based substrate may have a composition totaling 100 mol % including: from greater than or equal to 55 mol % to less than or equal to 75 mol % SiO₂; from greater than or equal to 11 mol % to less than or equal to 19 mol % Al₂O₃; from greater than or equal to 5.5 mol % to less than or equal to 9 mol % Li₂O; from greater than or equal to 0 mol % to less than or equal to 3 mol % P₂O₅; from greater than or equal to 1.5 mol % to less than or equal to 10 mol % Na₂O; from greater than or equal to 0 mol % to less than or equal to 0.1 mol % SnO₂; from greater than or equal to 0 mol % to less than or equal to 2.5 mol % B₂O₃; from greater than or equal to 0.1 mol % to less than or equal to 2 mol % ZnO; from greater than or equal to 0 mol % to less than or equal to 0.1 mol % CaO; from greater than or equal to 0 mol % to less than or equal to 0.8 mol % K₂O; from greater than or equal to 0 mol % to less than or equal to 3.0 mol % MgO; from greater than or equal to 0 mol % to less than or equal to 0.1 mol % Fe₂O₃; and from greater than or equal to 0 mol % to less than or equal to 0.1 mol % Ti₂O; and all values and subranges therebetween.

Glass-based substrates may be characterized by the bulk process in which they may be formed. For instance, the glass-based substrates may be characterized as float-formable (i.e., formed by a float process), down-drawable and, in particular, fusion-formable or slot-drawable (i.e., formed by a down draw process such as a fusion draw process or a slot draw process).

Some embodiments of the glass-based substrates described herein may be formed by a down-draw process. Down-draw processes produce glasses having a uniform thickness that possess relatively pristine surfaces. Because the average flexural strength of a glass article is controlled by the amount and size of surface flaws, a pristine surface that has had minimal contact has a higher initial strength. In addition, down drawn base glasses have a very flat, smooth surface that can be used in its final application without costly grinding and polishing.

Some embodiments of the glass-based substrates may be described as fusion-formable (i.e., formable using a fusion draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass sheet. The fusion draw method offers the advantage that, because the two glass films flowing over the channel fuse together, neither of the outside surfaces of the resulting glass article comes in contact with any part of the apparatus. Thus, the surface properties of the fusion drawn base glass are not affected by such contact. The fusion forming process results in a glass sheet having a “fusion line” where the two glass films overflowing each side of the drawing tank meet. A fusion line is formed where the two flowing glass films fuse together. The presence of a fusion line is one manner of identifying a fusion drawn glass. The fusion line may be seen as an optical distortion when the glass is viewed under an optical microscope.

Some embodiments of the glass-based substrates described herein may be formed by a slot draw process. The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous glass sheet and into an annealing region.

### EXAMPLES

Various embodiments will be further clarified by the following examples. In the Examples, prior to being strengthened, the Examples are referred to as “substrates”. After being subjected to strengthening, the Examples are referred to as “articles” or “glass-based articles”.

Glass substrates according to Compositions A-C were ion exchanged and the resulting articles tested.

Composition A had the following composition by mol %: 70.94% SiO₂, 1.86% B₂O₃, 12.83% Al₂O₃, 2.36% Na₂O, 8.22% Li₂O, 2.87% MgO, 0.83% ZnO, 0.02% Fe₂O₃, and 0.06% SnO₂.

Composition B had the following composition by mol %: 64.34% SiO₂, 15.29% Al₂O₃, 2.29% B₂O₃, 9.42% Na₂O, 6.02% Li₂O, 0.01% MgO, 1.21% ZnO, 0.06% SnO₂, 0.03% K₂O, 0.02% Fe₂O₃, 0.02% CaO, and 1.28% P₂O₅.

Composition C had the following composition by mol %: 63.70% SiO₂, 16.18% Al₂O₃, 0.39% B₂O₃, 8.10% Na₂O, 8.04% Li₂O, 0.33% MgO, 0.05% SnO₂, 0.53% K₂O, 0.02% Fe₂O₃, 0.01% Ti₂O, and 2.64% P₂O₅.

### Examples 1-6

Glass articles were formed based on substrates according to Composition A having dimensions of 50 mm by 50 mm by 0.8 mm, which were processed according to the conditions described in Table 1. There were 10 samples in each of the six Examples.

TABLE 1

| | High pH | Silane | | | Preheat | |
|---|---|---|---|---|---|---|
| Example | soak | Coating | Exposure | Ionization | (° C.) | IOX |
| 1 | pH 13 | YSAM | No | No | 250 | Standard |
| YSAM | | | | | | |
| 2 | pH 13 | YSAM | Air | Yes | 250 | Standard |
| YSAM_Air_Ionization | | | | | | |
| 3 | pH 13 | No | No | No | 250 | Standard |
| Control | | | | | | |
| 4 | pH 13 | No | Air | Yes | 250 | Standard |
| Control_Air_Ionization | | | | | | |
| 5 | pH 13 | No | No | No | 250 | 0.5% |
| NaNO₂ | | | | | | NaNO₂ |
| 6 | pH 13 | No | Air | Yes | 250 | 0.5% |
| Air_Ionization_NaNO₂ | | | | | | NaNO₂ |

Ultrasonic cleaning occurred using an ultrasonic cleaner with a solution at a pH of 13, containing 2% Semiclean KG, at 70° C. for 12 minutes followed by rinsing with deionized water at 70° C. for 12 minutes. For the groups that had a silane coating applied, the coating was Octadecyldimethyl trimethoxysilylpropyl ammonium chloride (supplied as 60% in MeOH) (CAS number: 27668-52-6), referred to hereinafter as YSAM. The YSAM coating solution was an aqueous solution that included 998.5 ml of deionized water, 0.48 ml of acetic acid and 1.88 ml of YSAM or 0.1% YSAM and 0.048% acetic acid. The glass samples were dipped in the YSAM aqueous solution for 30 seconds, then rinsed in deionized water for 30 seconds, and then dried in nitrogen air. For the groups that were exposed to air, the glass samples were held in a rack exposed to air for 24 hours and were then briefly bellowed by ionized nitrogen gas for 15 to 30 seconds. In the preheating step, the glass samples were heated at 250° C. for 15 minutes. Standard IOX occurred in a molten salt bath of 93.5 wt % KNO₃ and 6.5 wt % NaNO₃ at 430° C. for 4.5 hours. IOX+NaNO₂ occurred in a molten salt bath of 93.5 wt % KNO₃, 6 wt % NaNO₃, and 0.5 wt % NaNO₂ at 430° C. for 4.5 hours. After ion exchange, the samples were cleaned and inspected by a PSV-590 cross-polarizer and the numbers of Level A-D defects were measured using a ZYGO® NEWVIEW™ 7300 Optical Surface Profiler manufactured by ZYGO® Corporation (surface roughness is reported as a mean surface roughness), the results for which are in Table 2.

TABLE 2

| | Yield | Total | Defect Classification | | | |
|---|---|---|---|---|---|---|
| Example | (%) | defect | A | B | C | D |
| 1 | 80 | 2 | — | 2 | — | — |
| YSAM | | | | | | |
| 2 | 90 | 1 | 1 | — | — | — |
| YSAM_Air_Ionization | | | | | | |
| 3 | 70 | 3 | — | 2 | 2 | — |
| Control | | | | | | |
| 4 | 80 | 2 | — | 2 | — | — |
| Control_Air_Ionization | | | | | | |
| 5 | 70 | 3 | — | 2 | 1 | — |
| NaNO₂ | | | | | | |
| 6 | 100 | 0 | — | — | — | — |
| Air_Ionization_NaNO₂ | | | | | | |

Table 3 and FIG. 5 show the defect rate and yield of samples with and without the YSAM temporary coating.

TABLE 3

| | | | | Defect Classification | | |
|---|---|---|---|---|---|---|
| | Total | Yield ¹ | Yield ² | A | B | C |
| Examples | Sample | (%) | (%) | (%) | (%) | (%) |
| 1&2 | 20 | 85 | 100 | 5 | 10 | — |
| YSAM | | | | | | |
| 3-6 | 40 | 80 | 92.5 | — | 15 | 7.5 |
| NO YSAM | | | | | | |
| 2, 4, 6 | 30 | 90 | 100 | 3.3 | 6.7 | — |
| Air_Ionization | | | | | | |
| 1, 3, 5 | 30 | 73 | 90 | — | 20 | 10 |
| NO | | | | | | |
| Air_Ionization | | | | | | |

¹ Count all defects
² Count only defects “A” and “B” and exclude “C”

Based on Examples 1 and 2 of Table 3 and FIG. 5, the presence of the YSAM temporary coating resulted in articles having fewer dents, and the dents were only Level A and B dents, whereas Examples 3-6 without the YSAM temporary coating had a greater percentage of dents and the dents were Level B and C.

Based on Examples 2, 4, and 6, samples that were ionized had a substantially lower percentage of dents and the dents were Level A and B, whereas for Examples 1, 3, and 5, the samples that were not ionized have a greater percentage of dents and the dents were Level B and C.

### Examples 7-14

Glass articles were formed based on substrates according to Composition A having a thickness of 0.8 mm, Composition B having a thickness of 0.8 mm, and Composition C having a thickness of 0.6 mm, which were processed according to the conditions described in Table 4.

TABLE 4

| | | | | | KNO₃/NaNO₃/ | |
|---|---|---|---|---|---|---|
| | | | IOX | | Na₂CO₃ | Silicic |
| | | Surface | temperature | Time | (wt %/wt %/ | Acid |
| Example | Composition | Condition | (° C.) | (minutes) | wt %) | (wt %) |
| 7 | A | Detergent cleaned, | 380 | 960 | 93.5/6.5/0 | 0.5 |
| | | and exposed to air | | | | |
| | | for 24 hours | | | | |
| 8 | A | Detergent cleaned, | 420 | 348 | 93.5/6.5/0 | 0.5 |
| | | and exposed to air | | | | |
| | | for 24 hours | | | | |
| 9 | A | Detergent cleaned, | 460 | 126 | 93.5/6.5/0 | 0.5 |
| | | and exposed to air | | | | |
| | | for 24 hours | | | | |
| 10 | B | NO detergent cleaning, | 380 | 240 | 30/70/0 | 0.5 |
| | | and exposed to air | | | | |
| | | for 24 hours | | | | |
| 11 | B | NO detergent cleaning, | 420 | 84 | 30/70/0 | 0.5 |
| | | and exposed to air | | | | |
| | | for 24 hours | | | | |
| 12 | B | NO detergent cleaning, | 460 | 32 | 30/70/0 | 0.5 |
| | | and exposed to air | | | | |
| | | for 24 hours | | | | |
| 13 | C | NO detergent cleaning | 390 | 105 | 50/50/0 | 0.5 |
| 14 | C | NO detergent cleaning | 390 | 105 | 50/45/5 | n/a |

For Composition A only, ultrasonic cleaning was conducted by: glass was cleaned in solution containing 2% Semiclean KG (pH 13) at 70° C. for 12 minutes, then rinsed by DI water at 70° C. for 12 minutes.

All glasses were preheated at 250° C. for 15 minutes, then ion-exchanged (IOX'ed) in molten salt bath at the conditions described in Table 4. After IOX, glass was cleaned and inspected by cross-polarizer (PSV-590).

Table 5 shows compressive stress (CS), depth of layer of the spike (DOLₛₚ), defect rates, and yields of the Examples of Table 4. Increasing or decreasing the temperature enables to determine conditions where one mechanism is predominant over the other one. For a given glass, the temperature and the time of ion exchange can be chosen such that the bulk diffusion length related to the ion exchange process was maintained constant. As a result, the glass surface etching or particle undercutting was either increased or decreased. Experimental conditions were chosen to achieve comparable level of surface compression and diffusion profile depth for a particular glass at the temperatures.

TABLE 5

| | | | Defect (%) | | | | |
|---|---|---|---|---|---|---|---|
| | CS | DOLₛₚ | | | | Total | Yield |
| Example | (MPa) | (μm) | A | B | C | Defect | (%) |
| 7 | 624 | 7.1 | 13 | 25 | 50 | 88 | 13 |
| 8 | 349.5 | 8.175 | 0 | 11 | 33 | 44 | 56 |
| 9 | 663.25 | 8.525 | 0 | 0 | 0 | 0 | 100 |
| 10 | 774.67 | 8.5 | 0 | 20 | 70 | 90 | 10 |
| 11 | 778.25 | 8.55 | 10 | 20 | 40 | 70 | 30 |
| 12 | 763.75 | 8.55 | 0 | 10 | 50 | 60 | 40 |
| 13 | — | — | — | — | — | 0 | 100 |
| 14 | — | — | — | — | — | 93 | 7 |

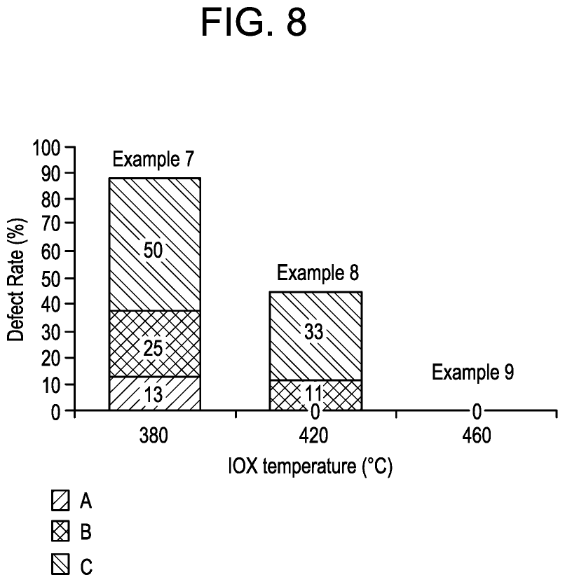

FIG. 8 is a chart showing the defect rate for various IOX bath temperatures for Examples 7-9, showing that dent defect rate was significantly reduced by increasing IOX bath temperature. For Composition A, as shown by Example 9, at 460° C., the defect rate was 0%, and yield was 100%. For Composition C, Example 14, adding 5 wt % Na₂CO₃ to IOX bath increased tank pH, and defects were reduced to 0%. It is preferable that the glass is cleaned before IOX to remove the majority of surface contamination. For Composition B, the results also showed high temperature can reduce the defect rate. But without cleaning the glass before IOX, in Example 12, some defects still showed up even on the samples IOX at 460° C.

It will be apparent to those skilled in the art that various modifications and variations can be made without departing from the spirit or scope of the invention.

What is claimed is:

1-55. (canceled)

56. A method of manufacturing a glass-based article comprising:
treating at least one surface of a glass-based substrate for protection of the at least one surface from contamination and/or for removal of contaminants from the at least one surface by a treatment other than ultrasonic cleaning; and
exposing the glass-based substrate to an ion exchange treatment after the treating step to form the glass-based article.

57. The method of claim 56, wherein the glass-based substrate comprises finished edges.

58. The method of claim 56, wherein the treating step comprises:
exposing the at least one surface to a high pH solution for removal of contaminants;
ionizing the at least one surface for removal of contaminants; and/or
applying a temporary coating to the at least one surface for protection of the at least one surface from contamination, and removing the temporary coating prior to the ion exchange treatment step.

59. The method of claim 56, wherein the ion exchange treatment comprises self-cleaning conditions.

60. The method of claim 59, wherein the self-cleaning conditions comprise a pH of greater than or equal to 7 and less than or equal to 11; and/or a temperature of greater than or equal to 460° C. and less than or equal to 520° C.

61. The method of claim 56, wherein the ion exchange treatment comprises a molten salt bath, and the method further comprises adding a salt to increase pH of the molten salt bath and/or setting a temperature of the molten salt bath to greater than or equal to 460° C.

62. The method of claim 56, further comprising prior to exposing the glass-based substrate to the ion exchange treatment: exposing the glass-based substrate to an ultrasonic cleaning comprising an ultrasonic bath, wherein a pH of the ultrasonic bath is in the range of greater than or equal to a pH of 9 to less than or equal to a pH of 13 and a temperature of the ultrasonic bath is in the range of greater than or equal to 40° C. to less than or equal to 70° C.

63. The method of claim 58, comprising the exposing the at least one surface to the high pH solution, wherein the exposing comprises the high pH solution having a pH of greater than or equal to 13 and less than or equal to 14 at a temperature in the range of greater than or equal to 65° C. to less than or equal to 75° C., and a duration in the range of greater than or equal to 10 minutes to less than or equal to 30 minutes.

64. The method of claim 58, comprising the ionizing, wherein the ionizing comprises applying an ionized gas to the at least one surface.

65. The method of claim 58, comprising the applying the temporary coating, wherein the temporary coating comprises an organo-silane compound and further comprising heating the glass-based substrate to remove the temporary coating prior to the exposing of the glass-based substrate to the ion exchange treatment.

66. A method of manufacturing a glass-based article comprising:
obtaining a glass-based substrate having finished edges,
ultrasonic cleaning of the glass-based substrate to form a cleaned substrate;
quality control inspecting the cleaned substrate;
loading the cleaned substrate;
preheating the cleaned substrate; and
ion exchange treating the cleaned substrate,
wherein:
before the ultrasonic cleaning, exposing the at least one surface to a high pH soaking for removal of contaminants;
after the loading and before the preheating, ionizing the at least one surface for removal of contaminants; and/or
after the ultrasonic cleaning and before the loading, applying a temporary coating to the at least one surface for protection of the at least one surface from contamination, and removing the temporary coating by heating prior to the ion exchange treating step.

67. The method of claim 66, wherein the ion exchange treating comprises a molten salt bath, the method further comprising adding a salt to the molten salt bath to increase the pH of the molten salt bath and/or setting a temperature of the molten salt bath to greater than or equal to 460° C.

68. The method of claim 66, wherein the ultrasonic cleaning comprises an ultrasonic bath having a pH in the range of greater than or equal to a pH of 9 to less than or equal to a pH of 13 and a temperature in the range of greater than or equal to 40° C. to less than or equal to 70° C.

69. The method of claim 66, further comprising after the quality control inspecting and before the loading, exposing the cleaned substrate to a second ultrasonic cleaning.

70. The method of claim 66, wherein after the ion exchange treatment, at least one surface of the glass-based article is free of dents having a depth greater than 80 nm.

71. A method of manufacturing a glass-based article comprising:
exposing at least one surface of a glass-based substrate to a high pH solution for removal of contaminants;
exposing the glass-based substrate to at least one additional finishing step; and
exposing the glass-based substrate to an ion exchange treatment to form the glass-based article.

72. The method of claim 71, wherein exposing the at least one surface of the glass-based substrate to the high pH solution comprises the high pH solution having a pH of greater than or equal to 13 and less than or equal to 14 at a temperature in the range of greater than or equal to 65° C. to less than or equal to 75° C., and a duration in the range of greater than or equal to 10 minutes to less than or equal to 30 minutes.

73. The method of claim 71, wherein the at least one further finishing step comprises ultrasonic cleaning of the glass-based substrate.

74. The method of claim 71, further comprising ionizing the at least one surface prior to the exposing of the glass-based substrate to the ion exchange treatment.

75. The method of claim 71, further comprising applying a temporary coating to at least one surface of the glass-based substrate and heating the glass-based substrate to remove the temporary coating prior to the exposing of the glass-based substrate to the ion exchange treatment.
